(19) United States
(12) Patent Application Publication
(10) Pub. No.: US 2026/0163313 A1
(43) Pub. Date: Jun. 11, 2026

(54) CONNECTOR HOLDER

(71) Applicants: SUMITOMO WIRING SYSTEMS, LTD., Mie-ken (JP); TOYOTA JIDOSHA KABUSHIKI KAISHA, Aichi-ken (JP)

(72) Inventors: Kengo TAKAGI, Yokkaichi-shi (JP); Mitsuhiro KATO, Kariya-shi (JP); Akinori ISHIKAWA, Totoya-shi (JP)

(73) Assignees: SUMITOMO WIRING SYSTEMS, LTD., Mie-ken (JP); TOYOTA JIDOSHA KABUSHIKI KAISHA, Aichi-ken (JP)

(21) Appl. No.: 19/405,547

(22) Filed: Dec. 2, 2025

(30) Foreign Application Priority Data
Dec. 6, 2024 (JP) 2024-213348

(51) Int. Cl. H01R 13/74

(52) U.S. Cl. CPC H01R 13/743

(57) ABSTRACT

A connector holder includes a temporary holding portion that temporarily holds a connector when inserted into the connector holder in an insertion direction extending along a first axis. The temporary holding portion includes a lower support that supports the connector from a lower side in a direction orthogonal to the insertion direction, and an upper wall facing the lower support and arranged at an upper side of the lower support. The lower support includes a temporary engaging projection that engages an engaging projection projecting from a lower surface of the connector in a removal direction, opposite the insertion direction, in which the connector is inserted between the lower support and the upper wall. The upper wall is elastically deformed by a force applied from the lower side so that an end of the upper wall located toward the removal direction is displaced upward.

### CROSS-REFERENCE TO RELATED APPLICATIONS

This application is based upon and claims the benefit of priority from Japanese Patent Application No. 2024-213348, filed on December 6, 2024, the entire contents of which are incorporated herein by reference.

### BACKGROUND

### Field

The present disclosure relates to a connector holder.

### Description of Related Art

JP2020-149792A discloses a connector holder including a temporary holding portion that temporarily holds a connector when the connector is inserted in an insertion direction extending along a first axis. The temporary holding portion includes a retaining projection that engages an engaging portion of the connector in a removal direction, which is opposite the insertion direction when the connector is temporarily held by the temporary holding portion. The retaining projection includes a vertical surface that is orthogonal to the first axis and engages the engaging portion of the connector, and an inclined surface that is inclined from an upper end of the vertical surface toward the top of the retaining projection. When the connector is removed from the temporary holding portion, the engaging portion of the connector is guided by the inclined surface from the upper end of the vertical surface to the top of the retaining projection and guided in the removal direction. This facilitates removal of the connector from the connector holder.

In the connector holder described above, the shape and the size of the vertical surface and the inclined surface greatly affects the performance of the temporary holding portion. Thus, for example, the vertical surface and the inclined surface have to be designed and manufactured with high precision so that the connector can be removed easily.

It is an objective of the present disclosure to provide a connector holder that facilitates removal of the connector.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a temporary holding portion temporarily holds a connector when the connector is inserted into a connector holder in an insertion direction extending along a first axis. The temporary holding portion includes a lower support configured to support the connector from a lower side in a direction orthogonal to the insertion direction, an upper wall facing the lower support and arranged at an upper side of the lower support, and a temporary engaging projection that engages an engaging projection projecting from a lower surface of the connector in a removal direction that is opposite the insertion direction in a state in which the connector is inserted between the lower support and the upper wall. The upper wall is elastically deformed from the lower side so that an end of the upper wall located toward the removal direction is displaced in an upward direction by a force applied from a lower side.

In accordance with the connector holder of the present disclosure, the connector holder facilitates removal of the connector.

Other features and aspects will be apparent from the following detailed description, the drawings, and the claims.

### BRIEF DESCRIPTION OF THE DRAWINGS

FIG. 1 is a perspective view showing a connector and part of a connector holder in accordance with an embodiment.

FIG. 2 is a perspective view showing the connector and part of the connector holder in accordance with the embodiment.

FIG. 3 is a perspective view of the connector in the embodiment.

FIG. 4 is a partial perspective view of the connector holder in accordance with the embodiment.

FIG. 5 is a cross-sectional view showing the connector and part of the connector holder and in accordance with the embodiment.

FIG. 6 is a partial cross-sectional view illustrating a process of temporarily holding the connector in a temporary holding portion in the embodiment.

FIG. 7 is a partial cross-sectional view illustrating a process of removing the connector from the temporary holding portion in the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Description of Embodiment of Present Disclosure

An embodiment in accordance with the present disclosure will now be described.

A connector holder of the present disclosure is:

A temporary holding portion that temporarily holds a connector when the connector is inserted into a connector holder in an insertion direction extending along a first axis. The temporary holding portion includes a lower support configured to support the connector from a lower side in a direction orthogonal to the insertion direction, an upper wall facing the lower support and arranged at an upper side of the lower support, and a temporary engaging projection that engages an engaging projection projecting from a lower surface of the connector in a removal direction that is opposite the insertion direction in a state in which the connector is inserted between the lower support and the upper wall. The upper wall is elastically deformed by a force applied from the lower side so that an end of the upper wall located toward the removal direction is displaced in an upward direction.

[1] With this structure, when the connector is inserted between the lower support portion and the upper wall, the lower support portion includes the engaging projection, which projects from the lower surface of the connector, and the temporary engaging projection, which engages the engaging projection in the removal direction that is opposite the insertion direction. This restricts separation of the connector disengaging from the temporary holding portion. Thus, when the connector is temporarily held in the temporary holding portion, even if the connector is pulled by a force applied from the removal direction, the connector will not be disengaged easily from the temporary holding portion. Further, the upper wall elastically deforms so that the end in the removal direction is displaced toward the upper side by the force applied from the lower side. This lifts the connector and elastically deforms the upper wall so that the end of the upper wall located toward the removal direction is displaced upward. Thus, the lifted connector allows the engaging projection to be disengaged from the temporary engaging portion. Accordingly, if the connector is pulled in the removal direction when the connector is lifted, the connector is removed from the temporary holding portion in a facilitated manner.

[2] According to [1], the lower support may be defined as a flat lower wall. In this structure, the lower support is a flat lower wall. This allows the lower side of the end of the connector located toward the removal direction to project downward so that the end of the connector can be easily lifted.

[3] According to [1] or [2], the temporary engaging projection may be located at an end of the lower support located toward the removal direction.

With this structure, the temporary engaging projection is located at the end of the lower support portion located toward the removal direction. This decreases the amount of elastic deformation of the upper wall required to disengage the engaging projection from the temporary engaging projection.

[4] According to any one of [1] to [3], the upper wall may include a pressing rib that projects toward the lower side and extends along the first axis.

With this structure, the upper wall includes the pressing rib, which projects toward the lower side and extends along the first axis. Thus, in a state in which the connector is temporarily held by the temporary holding portion, loosening of the connector is limited. Further, limited loosening of the connector avoids, for example, an unintentional disengagement of the engaging projection from the temporary engaging projection caused by vibration or the like.

[5] According to any one of [1] to [4], the lower support portion may include a guiding projection that projects toward the upper side, extends along the first axis, and is fitted to a guiding recess in a lower surface of the connector.

With this structure, the lower support portion includes the guiding projection, which projects toward the upper side, extends along the first axis, and is fitted into the guiding recess in the lower surface of the connector. This avoids misalignment of the connector when inserted into the temporary holding portion.

### Detailed Description of Embodiment of Present Disclosure

Specific examples of the present embodiment will now be described with reference to the drawings. In the drawings, elements are shown for illustrative purposes and may be partially exaggerated or omitted. Further, elements may not be drawn to scale. In the specification, “orthogonal” may not be strictly orthogonal and may be substantially orthogonal within a range that achieves the advantages of the present embodiment. In the specification, “facing” refers to a state in which two surfaces or two members face each other but is not limited to a state in which two surfaces or two members entirely face each other and includes a state in which they partially face each other. Further, “facing” includes both a case in which another member is located between two objects and a case in which no member is located between two objects. The present disclosure is not limited to these examples and is intended to include all modifications described by the scope of claims and corresponding to equivalents of the scope of claims.

### Structure of Connector Holder 10

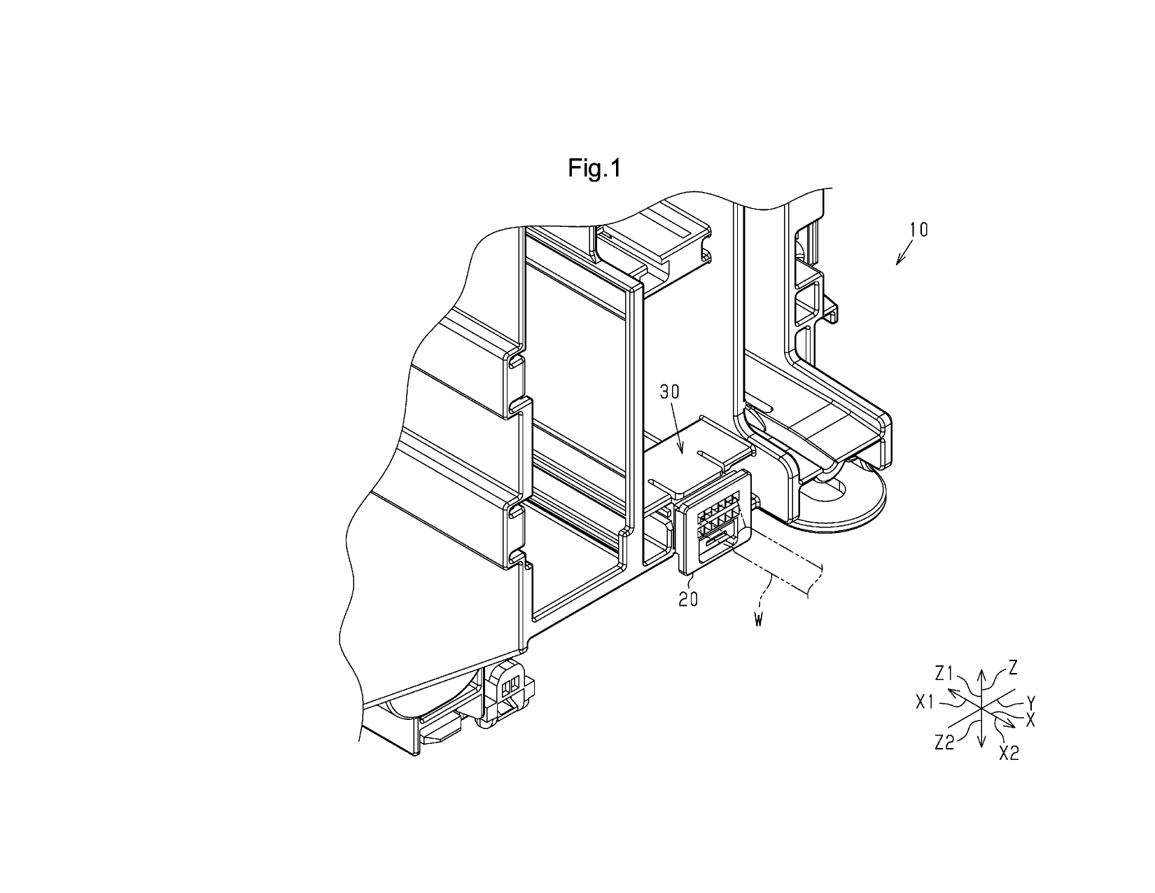

As shown in FIG. 1, a connector holder 10 includes a temporary holding portion 30 that temporarily holds a connector 20 when the connector 20 is inserted in an insertion direction X1 which extends along a first axis X. In the present embodiment, the connector holder 10 and the connector 20 are arranged in a vehicle. For example, in a vehicle, the connector holder 10 is arranged inside an instrument panel. As another example, the connector 20 is arranged on a distal end of a wire harness W connected to an electric device (not shown). The temporary holding portion 30 temporarily holds the connector 20 before the connector 20 is fitted to a mating connector (not shown).

Each drawing indicates a first axis X, a second axis Y orthogonal to the first axis X, and a third axis Z orthogonal to the first axis X and the second axis Y. Further, the drawings indicate an insertion direction X1, which extends toward one side along the first axis X, and a removal direction X2, which extends opposite to the insertion direction X1. The drawings also indicate an upward direction Z1, which extends toward one side along the third axis Z, and a downward direction Z2, which extends opposite to the upward direction Z1.

### Structure of Connector 20

The connector 20 is formed from resin.

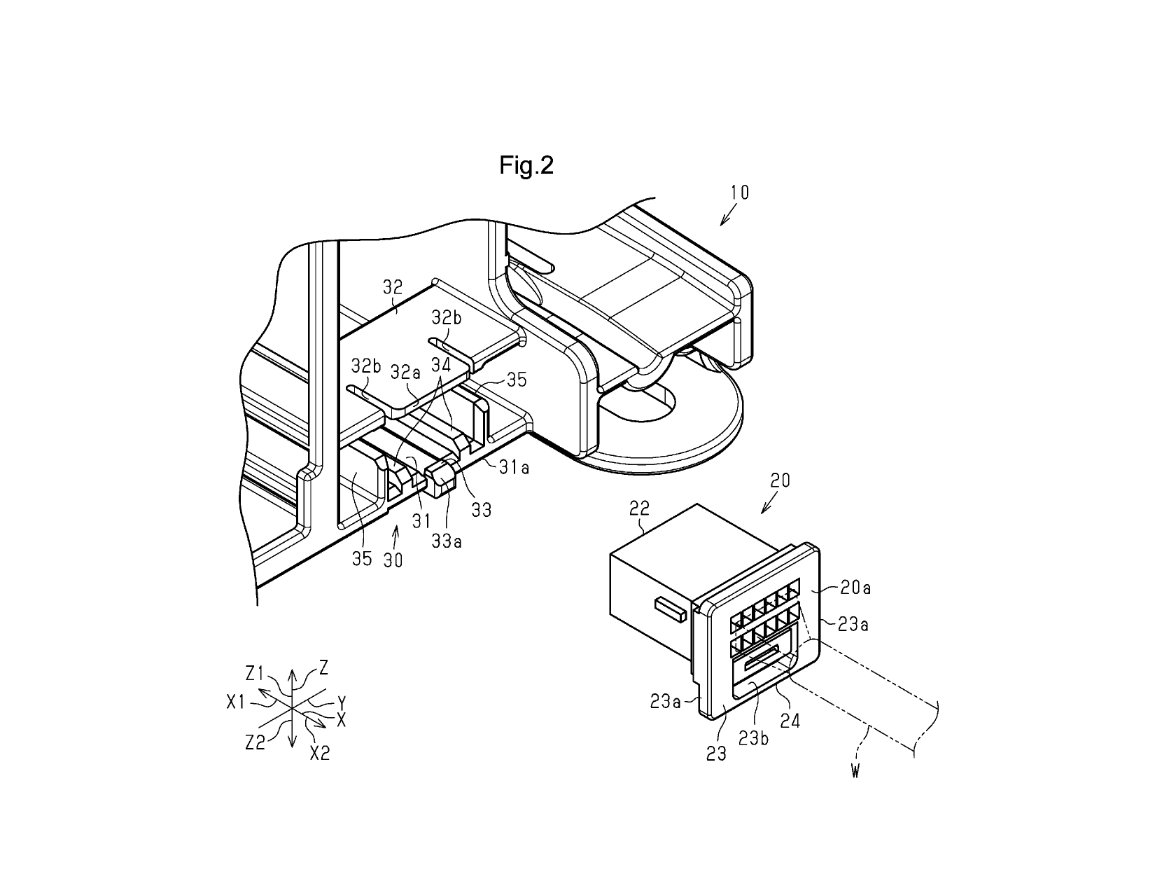

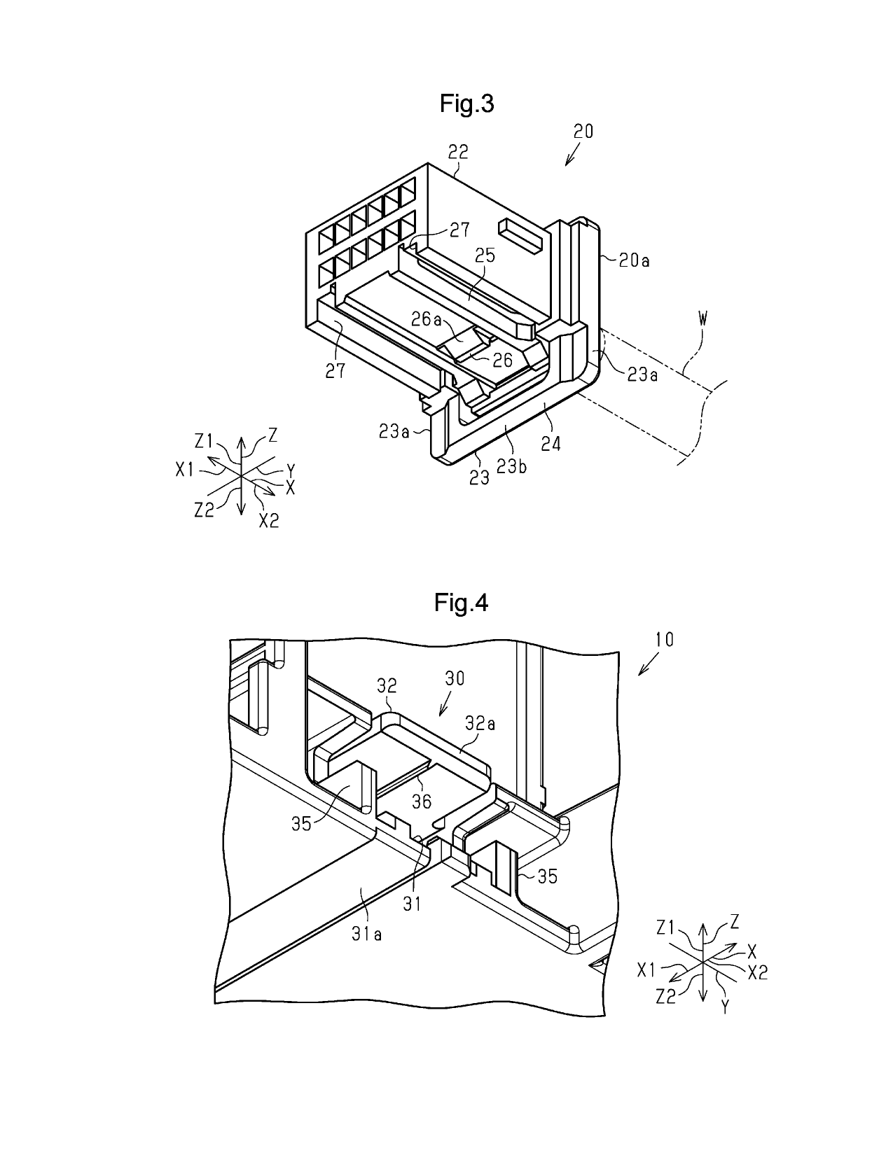

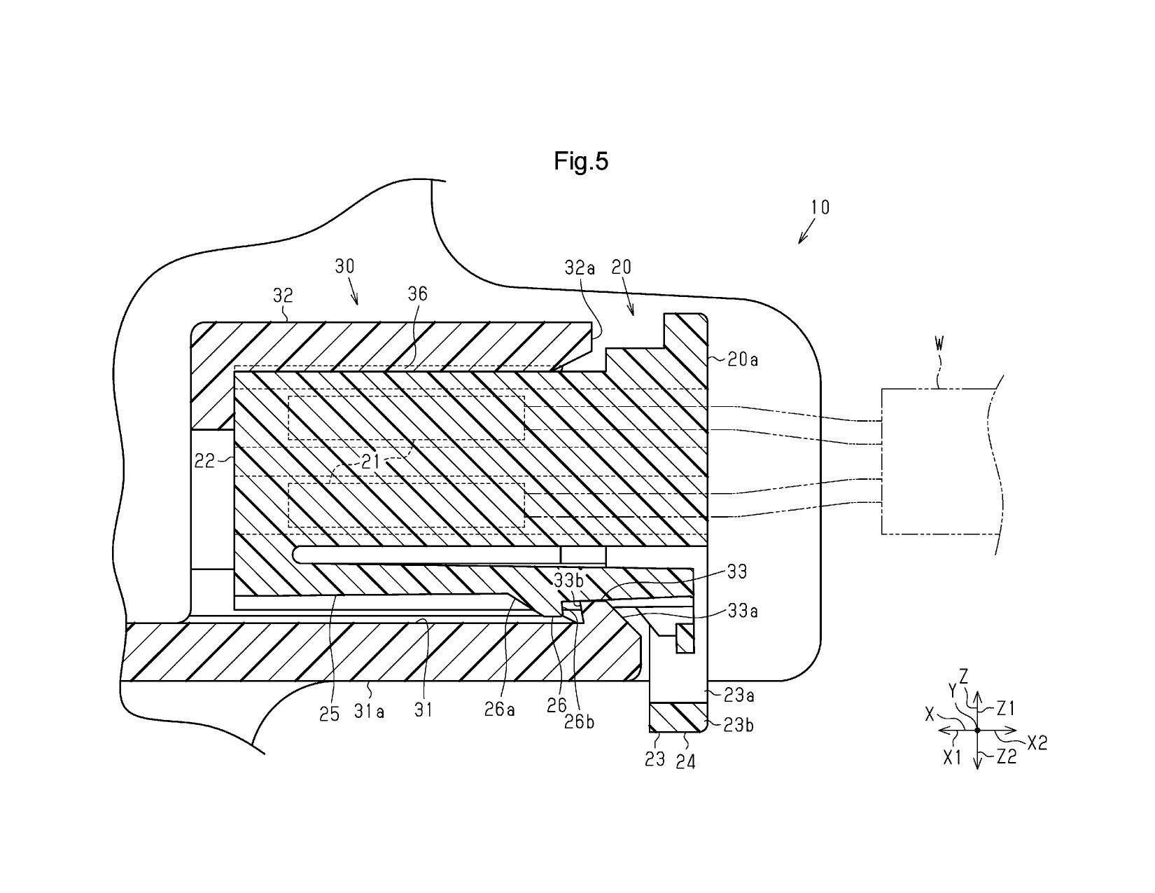

As shown in FIG. 2, the connector 20 includes a connector main body 22 that accommodates terminals 21 (refer to FIG. 5) arranged on a distal end of a wire harness W. In the present embodiment, the connector main body 22 accommodates twelve terminals 21. Thus, the wire harness W of the present embodiment includes a bundle of twelve wires. A terminal 21 is fixed to the end of each wire. The connector main body 22 is rectangular as viewed in the insertion direction X1 extending toward the temporary holding portion 30 (refer to FIG. 3). In the present embodiment, the connector main body 22 has an end located toward the removal direction X2 that includes a downward extension 23. The downward extension 23, which extends from a lower surface of the connector main body 22, includes two posts 23a and a coupling portion 23b. Each post 23a projects downward in the downward direction Z2 from two ends of the connector main body 22 located along the second axis Y. The coupling portion 23b couples the distal ends of the posts 23a. Accordingly, a lower end 24 of an end 20a located toward the removal direction X2 of the connector 20; that is, the lower end 24 of the downward extension 23 is located in the downward direction Z2 from the lower surface of the connector main body 22.

As shown in FIGS. 3 and 5, an elastic piece 25 is arranged on the lower surface of the connector main body 22 and is configured to be elastically deformed in the upward direction Z1. The elastic piece 25 is located in the central portion of the lower surface of the connector main body 22 with respect to the second axis Y and extends in the removal direction X2 from the end of the lower surface of the connector main body 22 located toward the insertion direction X1. More specifically, in the lower surface of the connector main body 22, the elastic piece 25 first projects in the downward direction Z2 from the end located toward the insertion direction X1, and then extends in the removal direction X2 from the distal end where the elastic piece 25 projects in the downward direction Z2. A distal end portion of the elastic piece 25 is located at a position surrounded by the connector main body 22 and the downward extension 23. Further, a lower surface of the elastic piece 25 includes an engaging projection 26 projecting in the downward direction Z2. The side of the engaging projection 26 located toward the insertion direction X1 includes an inclined portion 26a that gradually increases in projection amount from the lower surface of the elastic piece 25 in the removal direction X2.

Furthermore, as shown in FIG. 3, the lower surface of the connector main body 22 includes guiding recesses 27 that are open in the downward direction Z2 and extend in the insertion direction X1. Each guiding recess 27 extends to the end located toward the insertion direction X1. Thus, the guiding recess 27 is also open in the insertion direction X1. In other words, the guiding recess 27 has an opening in the downward direction Z2 and the insertion direction X1. In the present embodiment, the guiding recesses 27 are located on the two sides of the elastic piece 25.

### Structure of Temporary Holding Portion 30

The temporary holding portion 30 is formed from resin.

As shown in FIG. 2, the temporary holding portion 30 includes a lower support 31 and an upper wall 32. The lower support 31 is configured to support the connector 20 from the downward direction Z2. The upper wall 32 is arranged facing the lower support 31 and located in the upward direction Z1 from the lower support 31.

The lower support 31 includes a temporary engaging projection 33. The temporary engaging projection 33 is located in the central portion of the upper surface of the lower support 31 with respect to the second axis Y and projects in the upward direction Z1. When the connector 20 is inserted between the lower support 31 and the upper wall 32, the temporary engaging projection 33 is configured to engage the engaging projection 26 of the connector 20 in the removal direction X2. The side of the temporary engaging projection 33 located toward the removal direction X2 includes an inclined portion 33a that gradually increases in projection amount from the upper surface of the lower support 31 in the insertion direction X1. The temporary engaging projection 33 of the present embodiment is located at the end of the lower support 31 located toward the removal direction X2.

Further, the lower support 31 includes guiding projections 34. Each guiding projection 34 projects from the lower support 31 in the upward direction Z1 and extends along the first axis X. The guiding projection 34 is configured to be fitted into each guiding recess 27 of the connector 20. The guiding projections 34 are located at positions corresponding to the guiding recesses 27. In other words, the present embodiment includes two guiding projections 34. When the connector 20 is inserted into the temporary holding portion 30, more specifically, when the connector 20 is inserted between the lower support 31 and the upper wall 32, the guiding projections 34 guide the connector 20 so that the connector 20 moves linearly along the first axis X.

Further, the lower support 31 includes side walls 35. The side walls 35 project from the lower support 31 in the upward direction Z1 and extend along the first axis X. The lower support 31 includes two side walls 35 that are spaced apart from each other to allow for insertion of the connector 20.

As shown in FIG. 5, when the connector 20 is inserted between the lower support 31 and the upper wall 32, the connector 20 is temporarily held by the temporary holding portion 30. FIG. 5 is a cross section of the central part of the temporary holding portion 30 as viewed along the second axis Y when the connector 20 is temporarily held by the temporary holding portion 30 and taken along an X-Z plane.

In the state in which the connector 20 is temporarily held by the temporary holding portion 30, an end surface 33b of the temporary engaging projection 33 located toward the insertion direction X1 faces an end surface 26b of the engaging projection 26 in the removal direction X2. In this state, the end surface 33b of the temporary engaging projection 33 faces the end surface 26b of the engaging projection 26 along the first axis X. Thus, even if the connector 20 is pulled in the removal direction X2, the engaging projection 26 remains engaged with the temporary engaging projection 33.

Further, the lower support 31 of the present embodiment is defined by a flat lower wall 31a. The lower wall 31a and the upper wall 32 have the same thickness. When the connector 20 is temporarily held by the temporary holding portion 30, the lower end 24 in the end 20a of the connector 20 located in the removal direction X2, that is, the lower end 24 of the downward extension 23, projects in the downward direction Z2 from the lower wall 31a of the temporary holding portion 30.

The upper wall 32 will now be described in detail.

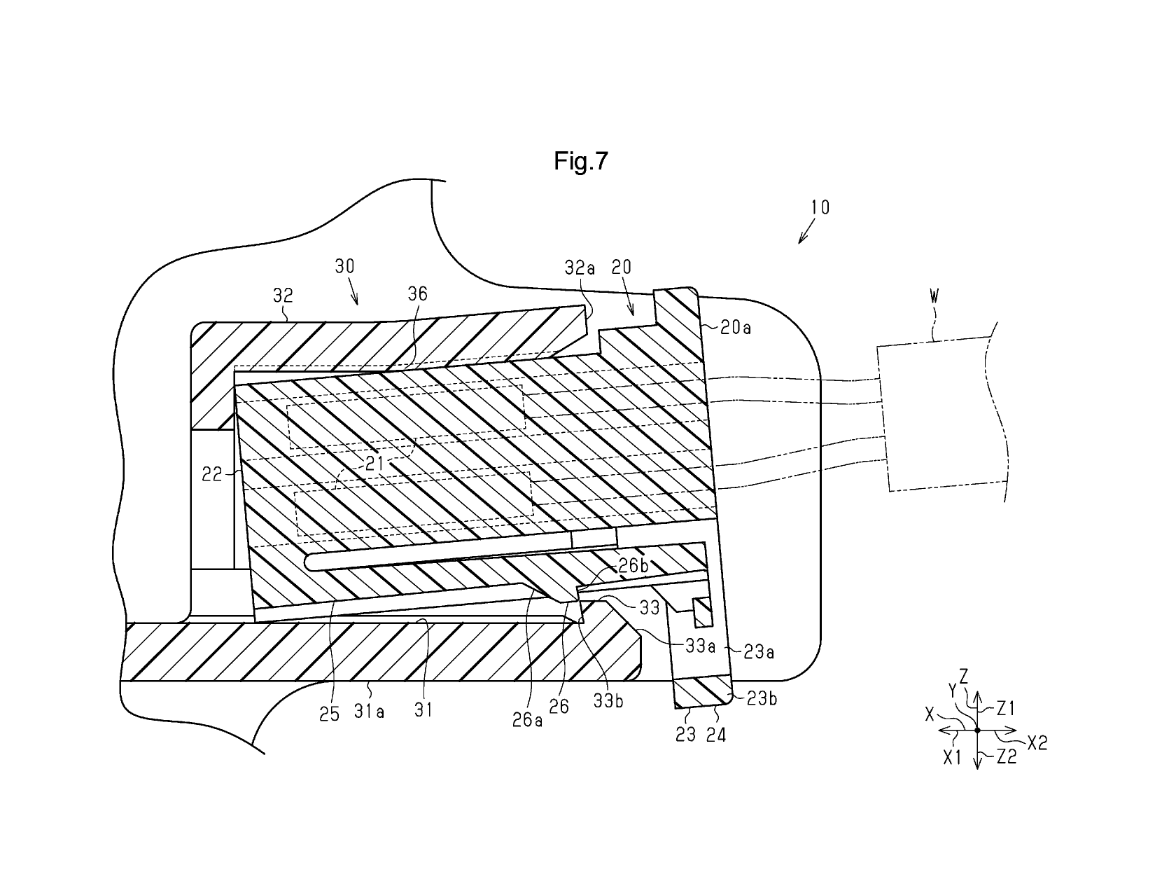

The upper wall 32 is elastically deformed by a force applied from the downward direction Z2 so that an end 32a of the upper wall 32 in the removal direction X2 is displaced in the upward direction Z1 (refer to FIG. 7). More specifically, as shown in FIG. 2, for example, the upper wall 32 of the present embodiment includes two slots 32b that extend along the first axis X from the end 32a located toward the removal direction X2 to the lengthwise middle part of the upper wall 32. Accordingly, the upper wall 32 is configured to elastically deform so that the end 32a located toward the removal direction X2, which is arranged between the two slots 32b, is allowed to be displaced in the upward direction Z1. The two slots 32b are located at positions corresponding to the two ends of the upper surface of the connector 20 with respect to the second axis Y. Elastic deformation of the upper wall 32 allows the connector 20 to be inclined about a centerline extending along the second axis Y.

As shown in FIG. 4, the upper wall 32 includes a pressing rib 36. The pressing rib 36 projects from the lower surface of the upper wall 32 in the downward direction Z2 and extends along the first axis X. The pressing rib 36 has a width along the second axis Y that decreases in the downward direction Z2. This allows the pressing rib 36 to be elastically deformed more easily toward its lower end.

### Operation of the Present Embodiment

The operation of the present embodiment will now be described.

The connector 20 is temporarily held by the temporary holding portion 30 by inserting the connector 20 into the temporary holding portion 30 in the insertion direction X1.

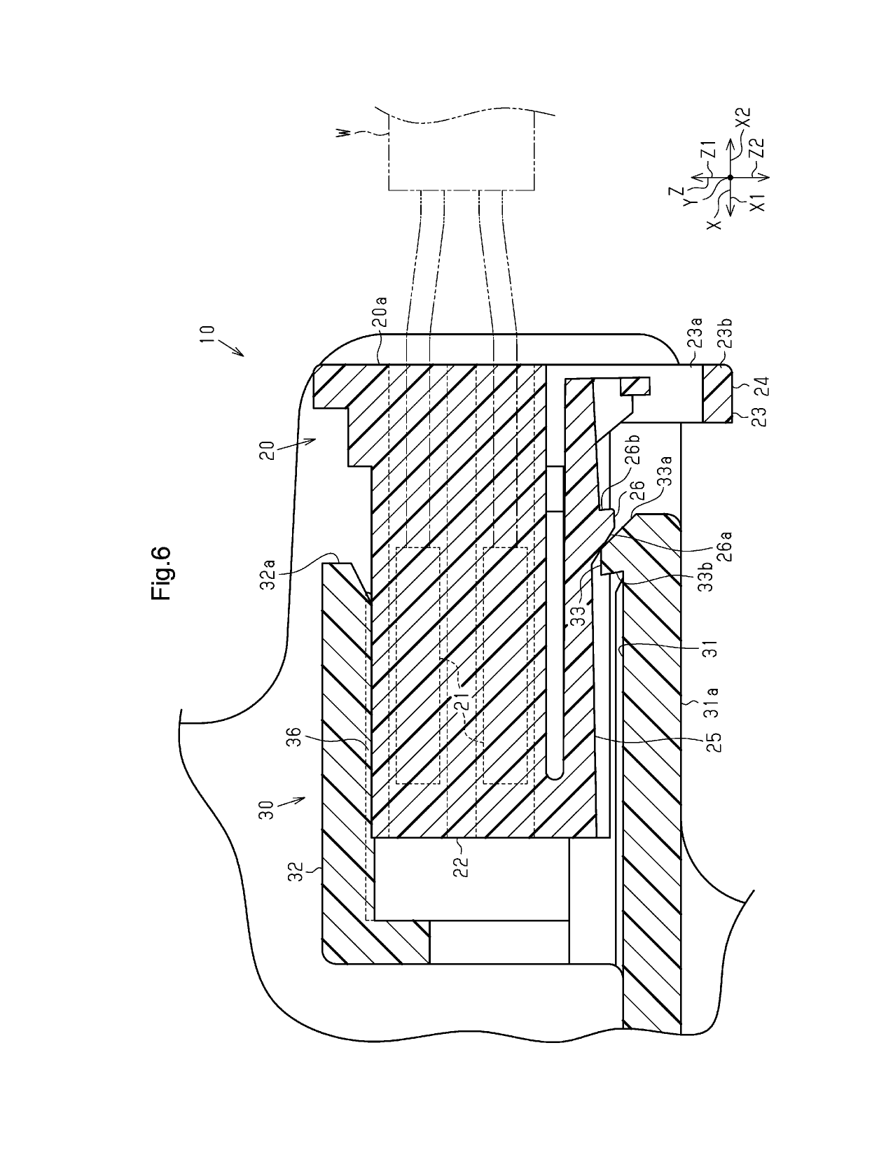

As shown in FIG. 6, the inclined portion 26a of the engaging projection 26 abuts the inclined portion 33a of the temporary engaging projection 33. This flexes the elastic piece 25, which includes the engaging projection 26, in the upward direction Z1 as the engaging projection 26 moves over the temporary engaging projection 33. When the connector 20 is inserted into the temporary holding portion 30, in accordance with the distance between the lower support 31 and the upper wall 32, the pressing rib 36 deforms elastically and pushes the connector 20 in the downward direction Z2. Accordingly, even if the connector 20 is pulled in the removal direction X2, the engagement of the engaging projection 26 and the temporary engaging projection 33 in the removal direction X2 restricts disengagement of the connector 20 from the temporary holding portion 30 (refer to FIG. 5).

Further, as shown in FIG. 7, when removing the connector 20 from the temporary holding portion 30, the lower end 24 of the end 20a of the connector 20 located toward the removal direction X2 is lifted in the upward direction Z1. Then, the connector 20 is pulled in the removal direction X2. More specifically, the upper wall 32 is formed so that the end 32a elastically deforms in the upward direction Z1 by force applied from the lower side. Thus, in a state in which the lower end 24 of the end 20a of the connector 20 is lifted in the upward direction Z1, the end 32a of the upper wall 32 is displaced in the upward direction Z1. Furthermore, in this case, the connector 20 is inclined so that the end 20a located toward the removal direction X2 is displaced in the upward direction Z1. This disengages the engaging projection 26 from the temporary engaging projection 33 in the removal direction X2. Thus, by pulling the connector 20 in the removal direction X2, the connector 20 is removed from the temporary holding portion 30.

### Advantages of the Present Embodiment

The advantages of the present embodiment will now be described.

When the connector 20 is inserted between the lower support 31 and the upper wall 32, the engaging projection 26, which projects from the lower surface of the connector 20, engages the temporary engaging projection 33 in the removal direction X2. This restricts removal of the connector 20 from the temporary holding portion 30. Thus, when the connector 20 is temporarily held by the temporary holding portion 30, for example, even if a pulling force is applied to the connector 20 in the removal direction X2, the connector 20 cannot be disengaged from the temporary holding portion 30. Further, the upper wall 32 is elastically deformed by force applied from the lower side so that the end 32a of the upper wall 32 located toward the removal direction X2 is displaced in the upward direction Z1. Thus, the connector 20 is lifted in the upward direction Z1 to elastically deform the upper wall 32 so that the end 32a of the upper wall 32 located toward the removal direction X2 is displaced in the upward direction Z1. When the connector 20 is lifted in the upward direction Z1, the engaging projection 26 can be disengaged from the temporary engaging projection 33. Accordingly, when the connector 20 is lifted in the upward direction Z1, by pulling the connector 20 in the removal direction X2, the connector 20 may be removed readily from the temporary holding portion 30.

The lower support 31 is defined by the flat lower wall 31a. This allows the lower end 24 in the end 20a of the connector 20 located toward the removal direction X2, more specifically, the lower end 24 of the downward extension 23, to easily project in the downward direction Z2 from the lower wall 31a. Thus, the end 20a of the connector 20 located toward the removal direction X2 can be easily lifted in the upward direction Z1.

The temporary engaging projection 33 is located at the end of the lower support 31 located toward the removal direction X2. This decreases the amount of elastic deformation of the upper wall 32 required to disengage the engaging projection 26 from the temporary engaging projection 33. For example, compared to when the temporary engaging projection 33 is located further in the insertion direction X1 from the end of the lower support 31 located in the removal direction X2, the amount of elastic deformation of the upper wall 32 required to disengage the engaging projection 26 and the temporary engaging projection 33 is less. By decreasing the elastic deformation of the upper wall 32, the amount of displacement of the connector 20 required to lift the connector 20 in the upward direction Z1 is decreased. This allows the connector 20 to be removed from the temporary holding portion 30 in a facilitated manner.

The upper wall 32 includes the pressing rib 36, which projects in the downward direction Z2 and extends along the first axis X. Thus, in a state in which the connector 20 is temporarily held by the temporary holding portion 30, loosening of the connector 20 is limited. Further, when loosening of the connector 20 is limited, for example, the unintentional disengagement of the engaging projection 26 and the temporary engaging projection 33 is avoided that would be caused by vibration or the like.

The lower support 31 includes the guiding projections 34 which project in the upward direction Z1, extend along the first axis X, and are fitted into the guiding recesses 27 in the lower surface of the connector 20. This avoids misalignment of the connector 20 when inserted into the temporary holding portion 30.

### Modifications

The above-described embodiment may be modified as follows. The above-described embodiment and the following modifications can be combined as long as the combined modifications remain technically consistent with each other.

In the above embodiment, the lower support 31 is defined by the flat lower wall 31a. However, this is not a limitation. The lower support 31 may have a varied thickness. For example, the end surface of the lower support 31 located toward the removal direction X2 may extend in the downward direction Z2 from the lower end 24 of the end 20a of the connector 20 located toward the removal direction X2.

In the above embodiment, the temporary engaging projection 33 is located at the end of the lower support 31 located toward the removal direction X2. However, this is not a limitation. The temporary engaging projection 33 may be located toward the insertion direction X1 from the end of the lower support 31 located toward the removal direction X2.

In the above embodiment, the upper wall 32 includes the pressing rib 36, which projects in the downward direction Z2 and extends along the first axis X. However, this is not a limitation. The pressing rib 36 does not need to extend along the first axis X. For example, the upper wall 32 may include a pressing rib 36 projecting in the downward direction Z2. Further, the upper wall 32 does not need to include the pressing rib 36.

The lower support 31 includes the guiding projections 34, which project in the upward direction Z1, extends along the first axis X, and are fitted in the guiding recesses 27 in the lower surface of the connector 20. However, this is not a limitation. The lower support 31 does not need to include the guiding projections 34. In this case, for example, to restrict displacement of the connector 20 when inserting into the temporary holding portion 30, the distance between the side walls 35 may be set with a high accuracy.

In the illustrated embodiment, the upper wall 32 of the temporary holding portion 30 is a flat plate including a cantilevered leaf spring arranged at the central part in the direction of the second axis Y. The width of the connector 20 in the direction of the second axis Y may be less than or equal to the width of the cantilevered leaf spring in the upper wall 32 of the temporary holding portion 30.

In the illustrated embodiment, the downward extension 23 of the connector 20 may be used as a finger grip portion or a lifting portion.

In the illustrated embodiment, the connector main body 22 may be referred to as a terminal protection case or a terminal protection hood configured to encompass the group of the terminals 21 of the connector 20. The connector main body 22 may be a polygonal case.

In the illustrated embodiment, an XY plane may be referred to as a reference plane of the connector holder 10.

In the illustrated embodiment, the lower wall 31a of the connector holder 10 may be referred to as a first connector support surface that resists elastic deformation or is elastically deformable by a limited first deformation amount. The upper wall 32 of the connector holder 10 may be referred to as a second connector support surface that is elastically deformable by a greater amount than the first deformation amount.

In the illustrated embodiment, as shown in FIGS. 2 and 4, the connector holder 10 may be in a state in which it does not receive the connector 20 or is completely separated from the connector 20. Such a state may be referred to as a free state of the connector holder 10. When the connector holder 10 is in the free state, the upper wall 32 and the lower wall 31a of the connector holder 10 may be parallel to the XY plane.

In the illustrated embodiment, as shown in FIG. 7, the connector holder 10 may be in a state in which it receives part of the connector 20 and/or is incompletely coupled to the connector 20. Such a state may be referred to as a transition state. When the connector holder 10 is in the transition state, the upper wall 32 of the connector holder 10 is in contact with and pressed by the connector main body 22. This elastically deforms the upper wall 32. When the connector holder 10 is in the transition state, the upper wall 32 of the connector holder 10 is not parallel to the XY plane. When the connector holder 10 is in the transition state, the lower wall 31a may be parallel to the XY plane but does not have to be parallel to the XY plane.

In the illustrated embodiment, as shown in FIGS. 1 and 5, the connector holder 10 may be in a state in which it receives the entire connector 20 and/or is completely coupled to the connector 20. Such a state may be referred to as a connector fitted state of the connector holder 10. When the connector holder 10 is in the connector fitted state, the upper wall 32 of the connector holder 10 may be in an elastically deformed state or be in a non-elastically deformed state. When the connector holder 10 is in the connector fitted state, the upper wall 32 and the lower wall 31a of the connector holder 10 may both be parallel to the XY plane but do not have to be parallel to the XY plane.

In the illustrated embodiment, the end 32a of the upper wall 32 and the temporary engaging projection 33 of the lower wall 31a define a connector port in which the distance is variable between the end 32a and the temporary engaging projection 33. The distance between the end 32a and the temporary engaging projection 33 in the connector port is greater when the connector holder 10 is in the transition state shown in FIG. 7 than when the connector holder 10 is in the free state shown in FIGS. 2 and 4 and greater than when the connector holder 10 is in the fitted state shown in FIGS. 1 and 5.

The present embodiment is to be considered as illustrative and not restrictive. In other words, the present disclosure is not limited to those exemplified and is shown by the scope of the claims. It is intended to include all modifications within the meaning and range equivalent to the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A connector holder, comprising:
a temporary holding portion that temporarily holds a connector when the connector is inserted into the connector holder in an insertion direction extending along a first axis, the temporary holding portion including
a lower support configured to support the connector from a lower side in a direction orthogonal to the insertion direction,
an upper wall facing the lower support and arranged at an upper side of the lower support, and
a temporary engaging projection that engages an engaging projection projecting from a lower surface of the connector in a removal direction that is opposite the insertion direction in a state in which the connector is inserted between the lower support and the upper wall,
wherein the upper wall is elastically deformed by a force applied from the lower side so that an end of the upper wall located toward the removal direction is displaced in an upward direction.

2. The connector holder according to claim 1, wherein the lower support is defined by a flat lower wall.

3. The connector holder according to claim 1, wherein the temporary engaging projection is located at an end of the lower support located toward the removal direction.

4. The connector holder according to claim 1, wherein the upper wall includes a pressing rib that projects toward the lower side and extends along the first axis.

5. The connector holder according to claim 1, wherein the lower support includes a guiding projection that projects toward the upper side, extends along the first axis, and is fitted to a guiding recess in a lower surface of the connector.
